(19) United States
(12) Patent Application Publication
(10) Pub. No.: US 2012/0223488 A1
(43) Pub. Date: Sep. 6, 2012

(54) Sealing material on hydraulic flange

(76) Inventors: Bum-Sun Kim, Busan (KR); Myoung-Gil Song, Gyeongsangnam-do (KR); Myoung-Wan Kim, Gyeongsangnam-do (KR)

(21) Appl. No.: 13/305,766

(22) Filed: Nov. 29, 2011

(30) Foreign Application Priority Data
Nov. 30, 2010 (KR) 2010-0125031

(51) Int. Cl. F16L 19/00

(52) U.S. Cl. 277/625

(57) ABSTRACT

The present invention relates to a sealing material for hydraulic fitting flanges, in more particular, a sealing material which is configured in a specific shape, departing from the shape of traditional O-rings, to prevent it from being separated from fitting flange, improve assembly work efficiency, eliminating the necessity of extra work step(s) for maintaining it at the intended position, and provide it with excellent sealing and retaining performance. To achieve the above mentioned objects, the sealing material, in compliance with the invention in a torus shape, placed in the sealing material groove of fitting is characterized by its inner diameter side or outer diameter side being formed in the shape to match with, or to be in contact with the corresponding face of the sealing material groove, and the lateral sides connecting the inner and outer diameter surfaces are formed with protruded areas.

### FIELD OF THE INVENTION

The present invention relates to a sealing material for hydraulic flange fittings, more particularly, a sealing material which is configured in a specific shape, departing from the shapes of traditional O-rings, to prevent it from being separated unwantedly from flange fitting, improve assembly work efficiency, eliminating the necessity of extra work step(s) for maintaining it at the intended position, and provide it with excellent sealing and retaining performance.

### BACKGROUND OF THE INVENTION

An O-ring, which is a kind of general sealing materials, is a rubber packing in a torus shape whose cross section is a circle. O-rings are used to prevent fluid, such as hydraulic oil, or gas from leaking out of mechanical system. They are used widely in almost all industries, since they are small in size, easy to use, and provide long service lives.

FIG. 1 shows a general O-ring sealing material, where, FIG. 1(a) is a front view and FIG. 1(b) is a cross-sectional view taken from line A-A of FIG. 1(a) As shown in FIG. 1, O-ring sealing materials in general are shaped in a torus having disc-shape cross section.

FIG. 2 shows a traditional O-ring installed in a flange fitting, where, FIG. 2(a) is a partial cross-sectional view of the O-ring (1) placed in the O-ring groove (3) of the flange fitting (2), and FIG. 2(b) is an enlarged, partial view showing the combination of the flange fitting (2) assembled with the O-ring (1) and adapter (2′).

The conventional O-rings (1) are relatively easily separated from the groove by impact or other causes in the course of moving to be coupled with the corresponding adapter (2′) after inserted into the O-ring groove (3) of the flange (2). Such separation results in lowering of work efficiency and damage of the O-ring by contamination.

In addition, sealing performance may be deteriorated due to twisted installation of O-ring in the O-ring groove (3) of the flange (2), or by the deformation or damage of the O-ring when coupling with adapter.

FIG. 3 is an explanatory drawing which illustrates a conventional O-ring installed in a flange fitting applied with hydraulic pressure. As shown in FIG. 3, a conventional O-ring (1), when the flange fitting (2) installed with the O-ring (1) and the adapter (2′) are coupled and applied with hydraulic pressure, deforms in the direction of the arrows—forming space in the O-ring—and may fail to provide desired sealing function.

FIG. 4 shows the modified shape of flange fitting designed to prevent O-ring from being easily separated.

As shown in FIG. 4, the tip of one side of the flange fitting (2), marked with the circle B, has to be shaped in a protrusion—a captive shape—to prevent O-ring from being separated.

Consequently, conventional O-rings require additional processing of flange fittings to prevent separation of O-rings, resulting in extra manufacturing cost. As such, studies have been conducted to improve sealing materials to solve above mentioned problems and weak points.

### CONTENTS OF THE INVENTION

### Task the Invention Strives to Solve

The goal of the present invention is to provide a hydraulic flange sealing material, which solves the above-described problems, improves assembly work efficiency, and prevents the seal from being separated easily, deformed or damaged when a flange fitting and an adapter are coupled.

In addition, the present invention provides a hydraulic flange sealing material, which can prevent twisted placement of O-ring into fitting, improve durability and pressure resistance by optimizing the stress caused by compression force, eliminate the necessity of extra process or configuration to prevent O-ring separation, improve maintenance/retention functionalities, and prevent fluid leakage.

### Means to Solve Tasks

According to the first view point of the present invention aiming at the achievement of above mentioned objects, the sealing material, in compliance with the invention in a torus shape, placed in the sealing material groove of fitting is characterized by its inner diameter side or outer diameter side being formed in the shape matching with the corresponding face of the sealing material groove.

In addition, according to the second view point of the present invention aiming at the achievement of above mentioned objects, the sealing material, placed in the sealing material groove of fitting is characterized by its inner diameter side or outer diameter side being formed to be in contact with the corresponding face of the sealing material groove.

The above first and second view points are further characterized by the inner diameter side and/or outer diameter side being formed in flat surface.

The sides connecting the inner diameter side and outer diameter side are characterized by being formed with flat areas and protruded areas.

It is desirable that the inner diameter side or outer diameter side in flat area be formed larger than the size of the corresponding face of the sealing material groove.

It is desirable that the protrusion be formed closer to the inner diameter side than the outer diameter side.

According to the third view point of the present invention, the sealing material, placed in the sealing material groove of fitting is characterized by being formed with the inner diameter surface, outer diameter surface, and the lateral sides which connect the inner and outer diameter surfaces and formed with protruded areas with tapered areas.

According to the fourth view point of the present invention, the sealing material, placed in the sealing material groove of fitting is characterized by being formed with the inner diameter surface, outer diameter surface, and the lateral sides which connect the inner and outer diameter surfaces and formed with the protruded parts the thickness (t2) of which is greater than the distance (t1) between the two side surfaces.

The sealing material according to above third and fourth view points is further characterized by the inner diameter surface and/or outer diameter surface being formed in flat surface.

It is desirable that the inner diameter surface or outer diameter surface be formed larger than the size of the corresponding face of the sealing material groove.

According to the fifth view point of the present invention, the sealing material, placed in the sealing material groove of fitting is characterized by being formed with the inner diameter surface, outer diameter surface, and the lateral sides which connect the inner and outer diameter surfaces and formed with flat areas and protruded areas.

In the above fifth view point, the flat and protruded areas on the inner and outer diameter surfaces are connected with tapered surfaces.

It is desirable that the protrusion be formed closer to the inner diameter surface than the outer diameter surface.

It is desirable that the protrusion have a wider width than the depth of the sealing material groove.

### Effects of the Invention

The hydraulic flange sealing material in compliance with the present invention provides the effects set forth and described hereinbelow.

First, improved shape of the sealing material facilitates assembly work.

Second, improved shape of the sealing material prevents the sealing material from being easily separated from groove.

Third, the sealing material in compliance with the present invention can improve sealing performance and prevent fluid leakage by preventing the sealing material from being deformed or damaged when coupling the flange fitting and adapter.

Fourth, improved shape of the sealing material prevents the sealing material from being twisted when inserted into fitting groove.

Fifth, the stress caused by compression force is optimized resulting in improved durability and pressure resistance.

Sixth, the time and cost for assembly work can be reduced since no additional means or extra configuration is required for preventing the sealing material from being separated from groove.

Seventh, maintenance/retention performance can be improved and fluid leakage can be prevented.

### BRIEF DESCRIPTION OF THE DRAWINGS

FIG. 1 shows a generic O-ring sealing material, where, FIG. 1(a) is a front view and FIG. 1(b) is a cross-sectional view taken from line A-A of FIG. 1(a)

FIG. 2 shows a traditional O-ring installed in a flange fitting, where, FIG. 2(a) is a partial cross-sectional view of the O-ring placed in the O-ring groove of the flange fitting, and FIG. 2(b) is an enlarged, partial view showing the combination of the flange fitting assembled with the O-ring and adapter.

FIG. 3 is an explanatory drawing which illustrates a conventional O-ring installed in a flange fitting applied with hydraulic pressure.

FIG. 4 shows the modified shape of flange fitting designed to prevent O-ring from being separated.

FIG. 5 is a plan view of the sealing material in compliance with the invention.

FIG. 6 is a cross-sectional view taken from line C-C of FIG. 5.

FIG. 7 is an enlarged view of the part D of FIG. 6.

FIG. 8 shows the state of the sealing material in compliance with the invention is placed in a flange fitting. FIG. 8(a) is a half cross-sectional view of the specification in the flange fitting, and FIG. 8(b) is a partial plane view of the flange fitting, assembled with the sealing material, coupled with an adapter.

FIG. 9 shows the state of the sealing material, placed in the flange fitting couple with the adapter, under hydraulic pressure.

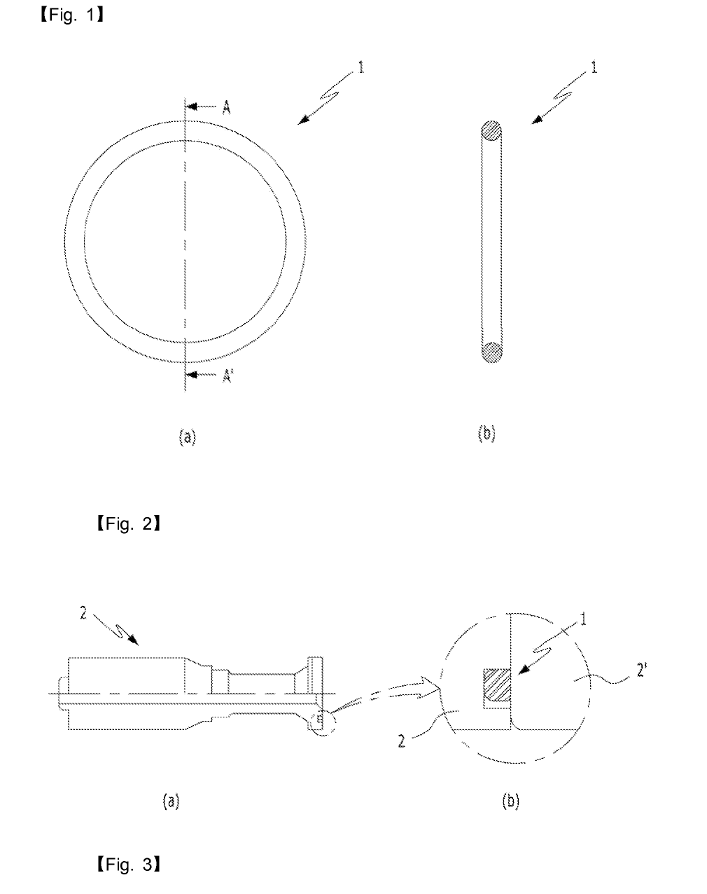

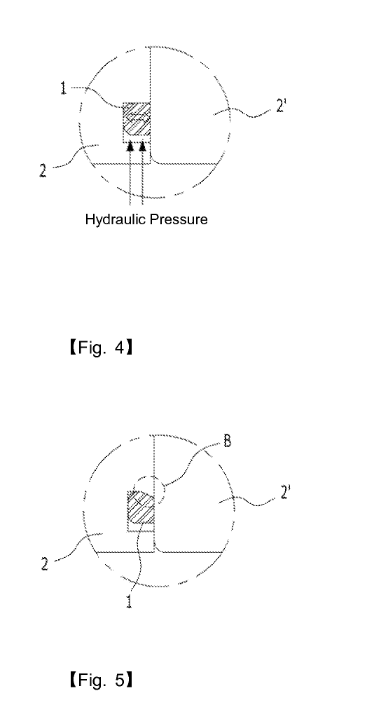

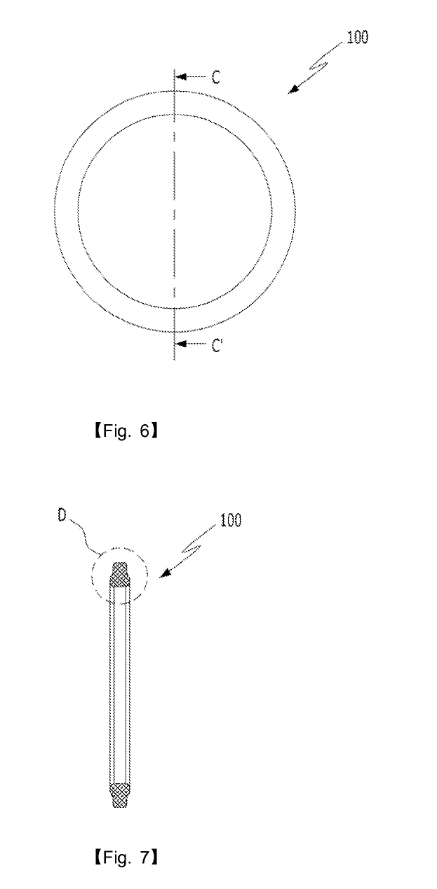

### DETAILED DESCRIPTION OF THE INVENTION

The additional objects, features and characteristics of the invention are set forth and described hereinbelow referring to the attached drawings.

According to the view point of the present invention, the sealing material in compliance with the invention, in a torus shape, placed in the sealing material groove of fitting is characterized by its inner diameter side and/or outer diameter side being formed in the shape matching with the corresponding face of the sealing material groove.

According to another view point of the present invention, the sealing material, in compliance with the invention, in a torus shape, placed in the sealing material groove of fitting is characterized by its inner diameter side and/or outer diameter side being so formed as to be contacted with the corresponding face of the sealing material groove.

The sides connecting the inner diameter side and outer diameter side are shaped in a planar surface having partial protrusion where the thickness is greater than that of other part.

The protrusion of the sealing material is characterized by being connected with the planar (flat) area of the lateral side by tapered surface.

Preferred embodiments of the hydraulic flange sealing material in compliance with the present invention are described in further detail by referring to the attached drawings.

FIG. 5 is a plan view of the sealing material in compliance with the present invention, FIG. 6 is a cross-sectional view taken from line C-C of FIG. 5, and FIG. 7 is an enlarged view of the part D of FIG. 6.

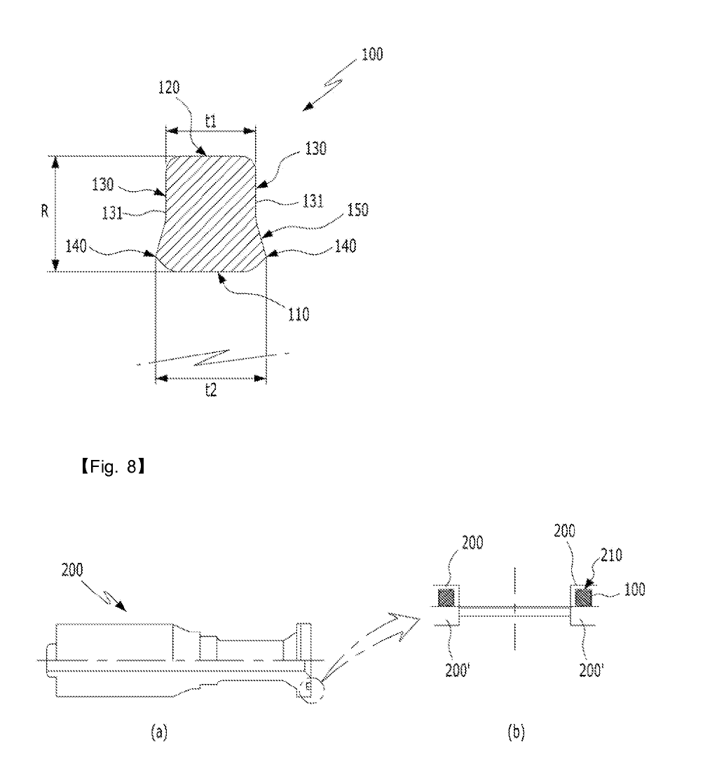

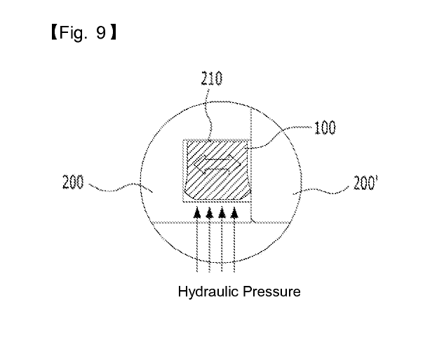

FIG. 8 shows the state of the sealing material in compliance with the invention is placed in a flange fitting. FIG. 8(a) is a half cross-sectional view of the specification in the flange fitting, and FIG. 8(b) is a partial plane view of the flange fitting, assembled with the sealing material, coupled with an adapter.

Firstly, as shown in FIGS. 5 through 7, the sealing material (100) in compliance with the present invention is an elastomeric ring to be assembled in sealing material groove of flange fitting, and is characterized by its specific cross-sectional shape, as shown in FIG. 7.

In more particular, the sealing material (100) in compliance with the present invention, as shown in FIG. 7, which is a ring to be inserted into the sealing material groove (210) of flange fitting, is formed with the inner diameter side (110), outer diameter side (120), and the lateral sides (130) connecting the inner and outer diameter sides (110)(120).

The inner diameter side (110) (hereinafter, “inner diameter surface”) and/or outer diameter side (120) (hereinafter, “outer diameter surface”) is formed with the surface in the shape matching with the corresponding surface of the sealing material groove (210) or plane contacting with the corresponding surface of the sealing material groove (210).

It is desirable that the thickness (t1) of the sealing material (100) shown in FIG. 7 be formed in a size greater than the length of the sealing material groove (210), in lengthwise, in which the sealing material (100) is to be inserted. Such design can increase the contact force between the sealing material (100) and the groove (210) and prevent the sealing material (100) from getting out of the groove (210) easily. The sealing material (100) in compliance with the present invention has a specific width (R) between the inner diameter surface (110) and outer diameter surface (120), in the radial direction of the O-ring itself. The width R of the sealing material (100) can be greater than the length of the sealing material groove (210).

In the preferred embodiment illustrated in the drawings, the inner diameter surface (110) is formed in flat area. This flat area can reduce the deformation of the sealing material and provide uniformly distributed perpendicular compressive force under hydraulic pressure, as described later in further detail.

In addition, the outer diameter surface (120) is formed in flat area. This shape can reduce the deformation of the sealing material under hydraulic pressure.

The lateral sides connecting the inner diameter surface and outer diameter surface are characterized by being formed with partial protrusion (140) whose thickness (t2) is greater than the thickness (t1) of other part.

In other words, the lateral sides (130) between the inner diameter surface (110) and outer diameter surface (120) consists of flat areas (131) and tapered, protruded areas (140). Therefore, the lateral sides (130) are formed with the protrusion (14) whose thickness is grater than the depth of the sealing material groove (210).

When the flange fitting (200), assembled with the sealing material (100), is coupled with the adapter (200′), as illustrated in FIG. 8, the protrusion (140) exerts compressive stress to provide initial sealing function.

It is desirable that the protrusion (140) be formed closer to the inner diameter surface (110) than the outer diameter surface (120). This configuration helps provide the initial sealing performance more reliably when hydraulic pressure is applied on to the inner diameter surface (110).

In addition, the sealing material (100) in compliance with the present invention is further characterized by being formed with its lateral sides (130) whose flat areas (131) and protruded areas (140) are connected with tapered surfaces (150), as shown in FIG. 7.

That is, the protruded surfaces (140) of the lateral sides (130) of the sealing material (100) are formed by tapered surfaces (150). In other words, the protruded surfaces (140) are outwardly tapered areas.

The tapered surface (150) provides adhering force by hydraulic pressure or being coupled with adapter which improves sealing performance.

The sealing material (100) in compliance with the present invention can be molded from oil-resistant rubber, other thermoplastic materials or other appropriate materials according to the characteristics and chemical properties of the fluid and the level of hydraulic pressure.

FIG. 9 shows the state of the sealing material, placed in the fitting flange coupled with the adapter, under hydraulic pressure. As shown in FIG. 9, under the hydraulic pressure in the arrow direction, the sealing material (100) exerts pressure to the groove walls and the adapter with durability and pressure resistance improved by the optimization of the compressive stress.

As described hereinabove, the sealing material with improved shape in compliance with the present invention enables easier application, improves the efficiency of assembly work, and is not easily separated from the groove since it is not twisted while being inserted into the groove.

The sealing material in compliance with the present invention is not easily removed from groove without using an appropriate tool, different from the conventional O-rings which can be removed relatively easily. Therefore, no additional procedure or separate configuration (a special shape of groove) is required to prevent sealing materials from escaping, thus resulting in increased performance and reduced costs in manufacture.

In addition, the sealing material in compliance with the present invention can prevent the deformation and damage which may be caused when coupling flange fitting and adapter, and improve sealing and retention performance.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

### Numbering Scheme of the Major Parts of the Drawings

100: Sealing Material

110: Inner Diameter Side (inner diameter surface)

120: Outer Diameter Side (outer diameter surface)

130: Lateral Side

131: Flat Area

140: Protrusion

150: Tapered Surface

200: Flange Fitting

200′: Adapter

1. A sealing material in a torus shape, being placed in the sealing material groove of fitting and characterized by its inner diameter side and/or outer diameter side being formed in the shape to match with the corresponding face of the above-mentioned sealing material groove.

2. A sealing material in a torus shape, being placed in the sealing material groove of fitting and characterized by its inner diameter side and/or outer diameter side being formed to be in contact with the corresponding face of the sealing material groove.

3. The sealing material of claim 1, wherein the above-mentioned inner diameter side and/or outer diameter side is characterized by being formed in a flat area.

4. The sealing material of claim 3, wherein the sides connecting the above-mentioned inner diameter side and outer diameter side are characterized by being shaped in a plane having partially-formed protrusion.

5. The sealing material of claim 4, wherein the inner diameter side or outer diameter side in a flat area is characterized by being formed in a size larger than that of the corresponding face of the sealing material groove.

6. The sealing material of claim 4, wherein the above-mentioned protrusion is characterized by being formed closer to the above-mentioned inner diameter side than the outer diameter side.

7. A sealing material in a torus shape, being placed in the sealing material groove of fitting and characterized by being formed with the inner diameter surface which is formed on the radially inner side, the outer diameter surface which is formed on the radially outer side, and the flat lateral sides which connect the above-mentioned inner and outer diameter surfaces and formed with protruded parts with tapered faces.

8. A sealing material in a torus shape, being placed in the sealing material groove of fitting and characterized by being formed with the inner diameter surface which is formed on the radially inner side, the outer diameter surface which is formed on the radially outer side, and the flat lateral sides which connect the above-mentioned inner and outer diameter surfaces and formed with the protruded parts whose thickness (t2) is greater than the distance (t1) between the above-mentioned two flat lateral sides.

9. The sealing material of claim 7, wherein the inner diameter side and/or outer diameter side is characterized by being formed in a flat area.

10. The sealing material of claim 9, wherein the inner diameter side or outer diameter side is characterized by being formed in a size larger than that of the corresponding face of the sealing material groove.

11. A sealing material in a torus shape, being placed in the sealing material groove of fitting and characterized by being formed with the inner diameter surface which is formed on the radially inner side, the outer diameter surface which is formed on the radially outer side, and the lateral sides which connect the above-mentioned inner and outer diameter surfaces formed with flat areas and protruded areas.

12. The sealing material of claim 11, wherein the flat areas and the protruded parts on the lateral sides are connected with tapered surfaces.

13. The sealing material of claim 7, wherein the protrusion is characterized by being formed closer to the inner diameter surface than the outer diameter surface.

14. The sealing material of claim 4, wherein the protrusion is characterized by being formed with a thickness greater than the depth of the sealing material groove.
